(19) United States
(12) Patent Application Publication
(10) Pub. No.: US 2025/0002139 A1
(43) Pub. Date: Jan. 2, 2025

(54) AN EMERGENCY INTERFACE SYSTEM FOR AN AUTOPILOT SYSTEM

(71) Applicant: Geoffrey BOND, Melbourne (AU)

(72) Inventor: Geoffrey BOND, Melbourne (AU)

(21) Appl. No.: 18/690,214

(22) PCT Filed: Sep. 21, 2022
(86) PCT No.: PCT/AU2022/051141

§ 371 Date: Mar. 7, 2024

(30) Foreign Application Priority Data
Sep. 22, 2021 (AU) 2021903048

(51) Int. Cl. B64C 13/50; B64C 13/04

(52) U.S. Cl. CPC B64C 13/506; B64C 13/044

(57) ABSTRACT

An emergency interface system for an autopilot system has an actuator mechanically interfacing an actuator switch, the actuator throwing the actuator switch when operated. The actuator switch has an actuator output connected to an input of an electrical latch, the latch having an activation output. The activation output interfaces an autopilot system, wherein the latch latches the activation output when the actuator output changes.

### FIELD OF THE INVENTION

This invention relates generally to an emergency interface system for an autopilot system, such as an aircraft autopilot system.

### BACKGROUND OF THE INVENTION

Conventional ways to prevent hijackers gaining unauthorised access to passenger aircraft cockpits to interfere with flight control typically entails securing cockpit doors.

The present invention seeks to provide a way to overcome or substantially ameliorate at least some of the deficiencies of the prior art, or to at least provide an alternative.

It is to be understood that, if any prior art information is referred to herein, such reference does not constitute an admission that the information forms part of the common general knowledge in the art, in Australia or any other country.

### SUMMARY OF THE DISCLOSURE

There is provided herein an emergency interface system for an autopilot or navigation system which comprises an actuator mechanically interfacing an actuator switch. The actuator throws the actuator switch when operated.

The actuator may take the form of a lever such as a concealed foot lever within a cockpit of an aircraft, vessel or the like.

The actuator switch has an actuator output connected to an input of an electrical latch.

The latch has an activation output which interfaces an autopilot system. The latch is configured to latch the activation output when the actuator output changes.

As such, for example, when the foot lever is temporarily depressed in an emergency situation, the actuator switch temporarily energises the latch thereby causing the latch to latch the activation output high or low/positive or negative, depending on the autopilot system input requirements.

The latch remains latched even if the foot lever is released. Furthermore, the latch may be located in an inaccessible part of the aircraft, vessel or the like so that it cannot be tampered with to unlatch.

The autopilot system is configured to enter an autopilot mode when the activation output changes. In this regard, the autopilot mode may be configured to return under autopilot to a preconfigured destination which, in embodiments, may be selected by the aircraft autopilot system depending on the current location of the aircraft or vessel. The preconfigured destination may be set prior departure, so that the preconfigured destination cannot be altered thereafter.

As such, once the actuator is activated in an emergency situation, neither the pilots nor any other unauthorised personnel can override the autopilot system returning to the preconfigured destination.

The present system may be used in aircraft, ships, trains and other modes of transportation.

For trains, and autopilot system thereof may be configured to only allow you trying to stop at certain train stations.

Other aspects of the invention are also disclosed.

### BRIEF DESCRIPTION OF THE DRAWINGS

Notwithstanding any other forms which may fall within the scope of the present invention, preferred embodiments of the disclosure will now be described, by way of example only, with reference to the accompanying drawings in which:

FIG. 1 shows an emergency of a system for an autopilot system.

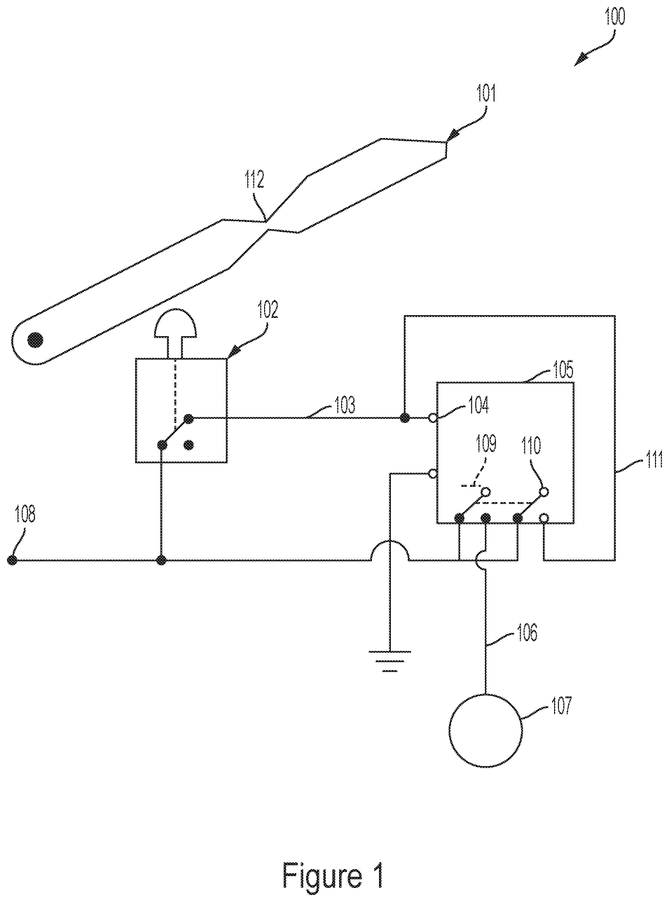

### DESCRIPTION OF EMBODIMENTS

An autopilot emergency interface system 100 comprises an actuator 101 mechanically interfacing in actuator switch 102. The actuator 101 throws the actuator switch 102 when operated. The actuator switch 102 has an actuator output 103 connected to an input 104 of an electrical latch 105. The latch 105 has an activation output 106. The activation output 106 interfaces and autopilot system 107.

The autopilot system 107 will be described hereunder as being an aircraft autopilot system 101 but it should be appreciated that the present system 100 may be used for other modes of transportation.

The latch 105 latches the activation output 106 when the actuator output 103 changes. In the embodiment shown, the actuator output 103 goes high when the actuator switch 102 is thrown. In embodiment shown, the actuator switch 102 comprises a Single Pole Double Throw (SPDT) switch.

The actuator switch 102 is connected in series with an aircraft power supply rail 108.

In the embodiment shown, the electrical latch 105 comprises a relay. The relay may be an electromechanical or a solid state relay.

The relay may be a Double Pole Double Throw (DPDT) switch having a first switch 109 switching the activation output 106 and a second switch 110 switching a feedback output 111. The feedback output 111 may be electrically connected to the input 104 of the latch 105 and connected in series with the aircraft power supply rail 108.

As such, when the actuator switch 102 is temporary thrown, the feedback output 111 goes high and feeds back into the latch 105 input 104 so that the latch 105 latches even if the actuator output 103 goes low again thereby ensuring that the activation output 106 remains high.

The latch 105 may be concealed in an inaccessible location of the aircraft so that the latch 105 cannot be deactivated once latched by the actuator switch 102.

In the embodiment shown, the actuator 101 comprises a lever which may take the form of a foot lever concealed within a cockpit of the aircraft.

In the embodiment shown, the foot lever 101 is frangible in that the lever 101 breaks when pressed. As is shown, the foot lever 101 may comprise an area of weakness 112 which causes the lever 101 to break in two and at the same time, activating the relay.

The aircraft autopilot system 107 may be configured to enter an autopilot mode of operation when the activation output 106 changes, such as going high.

In the autopilot mode of operation, the autopilot system 107 may be configured to return the aircraft under autopilot 107 to a preconfigured destination.

The autopilot system 107 may be configured to select a destination depending on the current location of the aircraft or vessel. As such, if the aircraft is closer to a destination airport, the autopilot system 107 may select the destination airport as opposed to the origin airport. With ships, an autopilot system thereof may be configured to travel to certain safety ports. With trains, an autopilot system thereof may be configured to either stop immediately, at the nearest station, or the next station having certain features, such as security personnel and/or equipment.

In embodiments, more than one system 100 is installed on an aircraft or other vessel. For example, two systems 100 may be installed in parallel for each of the pilot and co-pilot.

Once the aircraft or vessel has landed or reached a safety port/station and power shutdown, the system 100 resets the relay 105 in the event that it had been latched.

In embodiments, the present system 100 may interface a secondary autopilot system, the secondary autopilot system been subserving to a main autopilot system but wherein, when the system 100 is activated, the secondary autopilot system takes over control from the main autopilot system.

The foregoing description, for purposes of explanation, used specific nomenclature to provide a thorough understanding of the invention. However, it will be apparent to one skilled in the art that specific details are not required in order to practise the invention. Thus, the foregoing descriptions of specific embodiments of the invention are presented for purposes of illustration and description. They are not intended to be exhaustive or to limit the invention to the precise forms disclosed as obviously many modifications and variations are possible in view of the above teachings. The embodiments were chosen and described in order to best explain the principles of the invention and its practical applications, thereby enabling others skilled in the art to best utilize the invention and various embodiments with various modifications as are suited to the particular use contemplated. It is intended that the following claims and their equivalents define the scope of the invention.

1. An emergency interface system for an autopilot system, the emergency interface system comprising an actuator mechanically interfacing an actuator switch, the actuator throwing the actuator switch when operated, the actuator switch having an actuator output connected to an input of an electrical latch, the latch having an activation output, the activation output interfacing an autopilot system, wherein the latch latches the activation output when the actuator output changes, wherein the actuator comprises a foot lever which is frangible to break upon activation.

2. The emergency interface system as claimed in claim 1, wherein the actuator output goes high when the actuator switch is thrown.

3. The emergency interface system as claimed in claim 2, wherein the actuator switch comprises a Single Pole Double Throw (SPDT) switch.

4. The emergency interface system as claimed in claim 3, wherein the actuator switch is connected to an aircraft/vessel's power supply rail.

5. The emergency interface system as claimed in claim 1, wherein the electrical latch comprises a relay.

6. The emergency interface system as claimed in claim 5, wherein the relay is an electromechanical relay.

7. The emergency interface system as claimed in claim 5, wherein the relay is a Double Pole Double Throw (DPDT) switch having a first switch switching the activation output and a second switch switching a feedback output, the feedback output electrically connected to the input of the latch and connected in series with an aircraft system power supply rail.

8.-10. (canceled)

11. The emergency interface system as claimed in claim 1, wherein the foot lever comprises of an area of weakness which causes the foot lever to break in two.

12. The emergency interface system as claimed in claim 1, further comprising the autopilot system and wherein the autopilot system is configured to enter an autopilot mode when the activation output changes.

13. The emergency interface system as claimed in claim 12, wherein the autopilot mode is configured to return to a preconfigured destination under autopilot and wherein the autopilot mode cannot be disabled prior reaching the destination.

14. The emergency interface system as claimed in claim 13, wherein the autopilot system is configured to select the preconfigured destination from a set of preconfigured destinations depending on a current location.
